(19) United States
(12) Patent Application Publication
(10) Pub. No.: US 2020/0275330 A1
(43) Pub. Date: Aug. 27, 2020

(54) METHOD AND DEVICE FOR TRIGGERING NETWORK SWITCHING AND COMPUTER STORAGE MEDIUM

(71) Applicant: Guangdong OPPO Mobile Telecommunications Corp., Ltd., Dongguan (CN)

(72) Inventor: Hai Tang, Dongguan (CN)

(73) Assignee: Guangdong OPPO Mobile Telecommunications Corp., Ltd., Dongguan (CN)

(21) Appl. No.: 15/931,055

(22) Filed: May 13, 2020

Related U.S. Application Data
(63) Continuation of application No. PCT/CN2018/086390, filed on May 10, 2018.

(30) Foreign Application Priority Data
Nov. 13, 2017 (CN) PCT/CN2017/110752
Apr. 26, 2018 (CN) PCT/CN2018/084681

(51) Int. Cl. H04W 36/14; H04W 36/00; H04W 48/18; H04W 8/08

(52) U.S. Cl. CPC H04W 36/14; H04W 8/08; H04W 48/18; H04W 36/0022

(57) ABSTRACT

A method and apparatus for triggering a network handover, and a computer storage medium are provided. The method includes: determining, by an AMF of a 5G Core network, whether a switchover condition is satisfied. When determining that the switchover condition is satisfied, the method includes sending, by the AMF of the 5G Core network, a request message to a RAN node, wherein the request message comprises one of first indication information for indicating the RAN node to perform an inter-RAT switchover. Alternatively, second indication information for indicating the RAN node to perform an inter-system switchover. The handover is performed with an inter-system interface and the redirection is performed without the inter-system interface.

### CROSS-REFERENCES TO RELATED APPLICATIONS

This application is a continuation of and claims priority to International Patent Application PCT/CN2018/086390, filed May 10, 2018, which claims priority to International Patent Applications PCT/CN2017/110752, filed Nov. 13, 2017, and PCT/CN2018/084681, filed Apr. 26, 2018, the contents of which are hereby incorporated by reference in their entirety.

### BACKGROUND OF THE INVENTION

### Technical Field

The present invention relates to the field of mobile communication technologies, and in particular, to a method and an apparatus for triggering a network handover, and a computer storage medium.

### Related Art

A 5th generation mobile communications (5G) network tends to be diversified, broadband, integrated, and intelligent. In the early development, the 5G network needs to be compatible with a fourth generation mobile communication (4G) network, so that an intelligent terminal can select an appropriate network for surfing the internet as needed.

However, in some scenarios, a handover between networks needs to be implemented.

For example, after traffic used by a terminal on the 5G network reaches an upper limit, the 5G network is required to be handed over to the 4G network. At present, when a terminal needs to implement the handover between networks due to an event, the terminal often still resides on a current network. Accordingly, a policy needs to be used to trigger a network to perform a handover. For example, a network side controls, through adjusting a radio access technology frequency selection policy (RF SP), the terminal to perform the network handover at a moment after the event occurs. However, such handover mode causes the terminal to keep using the network to surf the internet after the event occurs (for example, after the traffic reaches the upper limit), resulting in additional network overheads and losing precise control of the traffic of the terminal.

### SUMMARY OF THE INVENTION

In order to resolve the foregoing technical problems, embodiments of the present invention provide a method and an apparatus for triggering a network handover, and a computer storage medium.

The method for triggering the network handover provided in an embodiment of the present invention includes sending, by a network element of a first core network, a request message to a base station when determining that a handover condition is satisfied, the request message being used to trigger the base station to perform a network handover process or a session modification process of a terminal.

In the embodiment of the present invention, the sending, by a network element of a first core network, a request message to a base station when determining that a handover condition is satisfied includes sending, by the network element of the first core network, the request message to the base station when determining that traffic used by the terminal on a first network exceeds a preset threshold.

In the embodiment of the present invention, that the network element of the first core network determines that traffic used by the terminal on a first network exceeds a preset threshold includes receiving, by the network element of the first core network, a first trigger message sent by a network element of a second core network, the first trigger message being used to indicate that the traffic used by the terminal on a first network exceeds the preset threshold.

In the embodiment of the present invention, the sending, by a network element of a first core network, a request message to a base station when determining that a handover condition is satisfied includes sending, by the network element of the first core network, the request message to the base station when determining that the terminal is using one or more specific applications on the first network.

In the embodiment of the present invention, the specific applications include at least one of the following an application that is not supported by the first network, an application that occupies an amount of resources of the first network that exceeds a preset value, an application that is not used on the first network required in subscription information, and an application that is in a low-priority transfer data packet in the subscription information, the low-priority transfer data packet meaning that a priority of the transfer data packet is lower than or equal to a preset priority.

In the embodiment of the present invention, subscription information includes attribute information corresponding to a plurality of applications, the attribute information including at least one of the following: feature information, service priority information, and importance degree information.

In the embodiment of the present invention, the sending, by a network element of a first core network, a request message to a base station when determining that a handover condition is satisfied includes sending, by the network element of the first core network, the request message to the base station when determining that the terminal moves into a target area or moves away from the target area, the request message being used to trigger the base station to perform the network handover process or the session modification process of the terminal.

In the embodiment of the present invention, the sending, by a network element of a first core network, a request message to a base station when determining that a handover condition is satisfied includes sending, by the network element of the first core network, the request message to the base station when receiving a second trigger message, the request message being used to trigger the base station to perform the network handover process or the session modification process of the terminal.

In the embodiment of the present invention, that the network element of the first core network receives a second trigger message includes receiving, by the network element of the first core network, a request message sent by a network element of a third core network.

In the embodiment of the present invention, that the network element of the first core network receives a second trigger message includes receiving, by the network element of the first core network, a service request message sent by the terminal, the service request message being used to indicate occurrence or a request handover of a specific service.

In the embodiment of the present invention, that the request message is used to trigger the base station to perform the network handover process or the session modification process of the terminal means that the request message is used to instruct the base station to perform a handover process that some or all of data flows of the terminal on a user plane are handed over from the first network to a second network.

In the embodiment of the present invention, the request message includes at least one of the following indication information: indication information based on an inter-system interface handover, indication information based on redirection without an inter-system interface, indication information of session establishment/request modification, or indication information for handing over a specified application data flow and/or session.

In the embodiment of the present invention, if the request message includes the indication information for handing over a specified application data flow and/or session, the request message further includes indication information for handing over, to a second base station that is connected to the second core network, the specified data flow and/or session from a current first base station that is connected to the first core network. Alternatively, the request message further includes indication information for handing over, to the second base station that is connected to the first core network, the specified data flow and/or session from the current first base station that is connected to the first core network.

In the embodiment of the present invention, the request message carries a network handover type, the network handover type including an access type handover or an access system handover.

An apparatus for triggering the network handover provided in an embodiment of the present invention includes a determining unit, configured to determine whether a handover condition is satisfied and a sending unit, configured to send a request message to a base station when the handover condition is satisfied, the request message being used to trigger the base station to perform a network handover process or a session modification process of a terminal.

In the embodiment of the present invention, the determining unit includes a first determining subunit, configured to determine whether traffic used by the terminal on a first network exceeds a preset threshold and the sending unit is specifically configured to send the request message to the base station when it is determined that the traffic used by the terminal on the first network exceeds the preset threshold.

In the embodiment of the present invention, the apparatus further includes a receiving unit, configured to receive a first trigger message sent by a network element of a second core network, the first trigger message being used to indicate that the traffic used by the terminal on the first network exceeds the preset threshold and the first determining subunit is specifically configured to determine, based on the first trigger message, whether the traffic used by the terminal on the first network exceeds the preset threshold.

In the embodiment of the present invention, the determining unit includes a fourth determining subunit, configured to determine whether the terminal is using one or more specific applications on the first network and the sending unit is specifically configured to send the request message to the base station when it is determined that the terminal is using one or more specific applications on the first network.

In the embodiment of the present invention, the specific applications include at least one of the following: an application that is not supported by the first network, an application that occupies an amount of resources of the first network that exceeds a preset value, an application that is not used on the first network required in subscription information, and an application that is in a low-priority transfer data packet in the subscription information, the low-priority transfer data packet meaning that a priority of the transfer data packet is lower than or equal to a preset priority.

In the embodiment of the present invention, subscription information includes attribute information corresponding to a plurality of applications, the attribute information including at least one of the following: feature information, service priority information, and importance degree information.

In the embodiment of the present invention, the determining unit includes a second determining subunit, configured to determine whether the terminal moves into a target area or moves away from the target area, and the sending unit is specifically configured to send the request message to the base station when it is determined that the terminal moves into the target area or moves away from the target area, the request message being used to trigger the base station to perform the network handover process or the session modification process of the terminal.

In the embodiment of the present invention, the determining unit includes a third determining subunit, configured to determine whether a second trigger message is received, and the sending unit is specifically configured to send the request message to the base station when the second trigger message is received, the request message being used to trigger the base station to perform the network handover process or the session modification process of the terminal.

In the embodiment of the present invention, the third determining subunit is specifically configured to determine whether a request message sent by a network element of a third core network is received.

In the embodiment of the present invention, the third determining subunit is specifically configured to determine whether a service request message sent by the terminal is received, the service request message being used to indicate occurrence or a request handover of a specific service.

In the embodiment of the present invention, that the request message is used to trigger the base station to perform the network handover process or the session modification process of the terminal means that the request message is used to instruct the base station to perform a handover process that some or all of data flows of the terminal on a user plane are handed over from the first network to a second network.

In the embodiment of the present invention, the request message includes at least one of the following indication information: indication information based on an inter-system interface handover, indication information based on redirection without an inter-system interface, indication information of session establishment/request modification, or indication information for handing over a specified application data flow and/or session.

In the embodiment of the present invention, if the request message includes the indication information for handing over a specified application data flow and/or session, the request message further includes indication information for handing over, to a second base station that is connected to the second core network, the specified data flow and/or session from a current first base station that is connected to the first core network, or indication information for handing over, to the second base station that is connected to the first core network, the specified data flow and/or session from the current first base station that is connected to the first core network.

In the embodiment of the present invention, the request message carries a network handover type, the network handover type including an access type handover or an access system handover.

A computer storage medium provided in the embodiment of the present invention stores a computer executable instruction, the computer executable instruction, when executed by a processor, implementing the foregoing method for triggering the network handover.

In technical solutions of the embodiments of the present invention, the request message is sent to the base station when the network element of the first core network determines that the handover condition is satisfied, the request message being used to trigger the base station to perform the network handover process or the session modification process of the terminal. According to the technical solutions of embodiments of the present invention, the network element of the first core network such as a Policy Control Function (PCF) network element or a Policy and Charging Rules Function (PCRF) network element can immediately trigger the base station to perform the network handover process of the terminal when it is determined that the handover condition is satisfied, avoiding additional network overheads caused by continuously surfing the internet on the original network by the terminal, and precisely controlling the traffic used by the terminal.

### BRIEF DESCRIPTION OF THE DRAWINGS

The accompanying drawings described herein are used for providing a further understanding of the present invention and constitute a part of this application. Exemplary embodiments of the present invention and the description thereof are used for explaining the present invention, and does not constitute any improper limitation on the present invention.

FIG. 1 is a system architecture diagram of a 5G network according to an embodiment of the present invention.

FIG. 2 is a system architecture diagram of a 4G network according to an embodiment of the present invention.

FIG. 3 is a schematic flowchart I of a method for triggering a network handover according to an embodiment of the present invention.

FIG. 4 is a schematic flowchart II of a method for triggering a network handover according to an embodiment of the present invention.

FIG. 5 is a schematic flowchart III of a method for triggering a network handover according to an embodiment of the present invention.

FIG. 6 is a schematic flowchart IV of a method for triggering a network handover according to an embodiment of the present invention.

FIG. 7 is a schematic flowchart V of a method for triggering a network handover according to an embodiment of the present invention.

FIG. 8 is a schematic flowchart VI of a method for triggering a network handover according to an embodiment of the present invention.

FIG. 9 is a schematic flowchart VII of a method for triggering a network handover according to an embodiment of the present invention.

FIG. 10 is a schematic flowchart VIII of a method for triggering a network handover according to an embodiment of the present invention.

FIG. 11 is a schematic flowchart IX of a method for triggering a network handover according to an embodiment of the present invention.

FIG. 12 is a schematic structural diagram I of an apparatus for triggering a network handover according to an embodiment of the present invention.

FIG. 13 is a schematic structural diagram II of an apparatus for triggering a network handover according to an embodiment of the present invention.

FIG. 14 is a schematic structural diagram of a terminal according to an embodiment of the present invention.

FIG. 15 is a flowchart of transferring a request message according to an embodiment of the present invention.

FIG. 16 is a flowchart I of transferring an application data flow and/or session identification information according to an embodiment of the present invention.

FIG. 17 is a flowchart II of transferring an application data flow and/or session identification information according to an embodiment of the present invention.

### DETAILED DESCRIPTION OF THE INVENTION

To provide a thorough understanding of the features and technical contents of the embodiments of the present invention, the implementation of the embodiments of the present invention is described in detail below with reference to the accompanying drawings. The accompanying drawings are only used for reference and description but are not intended to limit the embodiments of the present invention.

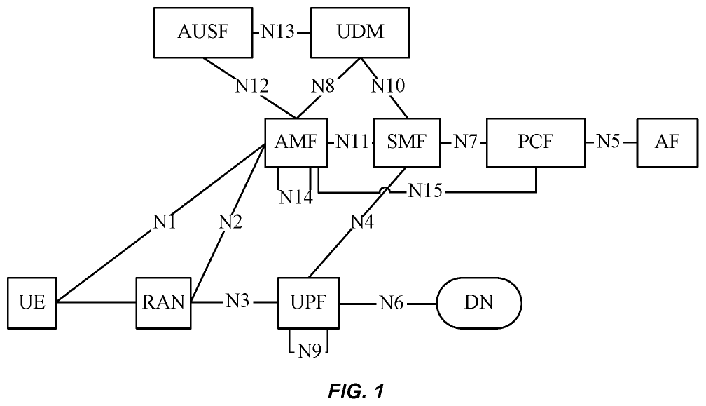

FIG. 1 is a system architecture diagram of a 5G network according to an embodiment of the present invention. As shown in FIG. 1, apparatuses involved in the 5G network include a user equipment (UE), a radio access network (RAN) apparatus, a user plane function (UPF) apparatus, a data network (DN) apparatus, a Core Access and Mobility Management Function (AMF) apparatus, a Session Management Function (SMF) apparatus, a Policy Control Function (PCF) apparatus, an Application Function (AF) apparatus, an Authentication Server Function (AUSF) apparatus, and a Unified Data Management (UDM) apparatus.

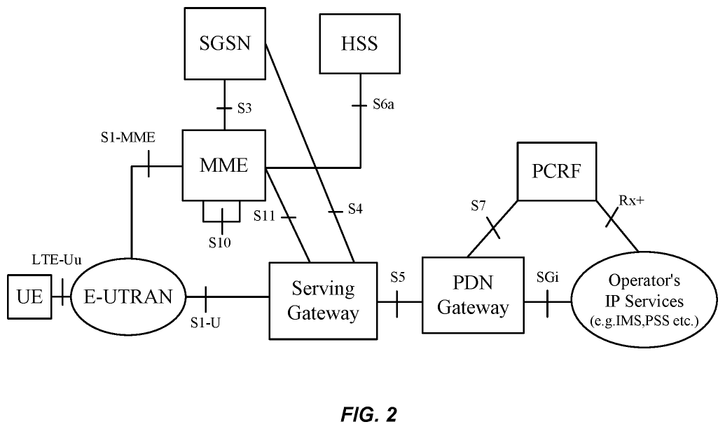

FIG. 2 is a system architecture diagram of a 4G network according to an embodiment of the present invention. As shown in FIG. 2, apparatuses involved in the 4G network include a user equipment (UE), an evolved universal terrestrial radio access network (E-UTRAN) apparatus, a Mobility Management Entity (MME) network element, a Serving GPRS Support Node (SGSN), a Home Subscriber Server (HSS), a serving gateway, a packet data network gateway (PDN Gateway), and a Policy and Charging Rules Function (PCRF) unit.

Examples in the foregoing FIG. 1 and FIG. 2 are only one network architecture example for implementing the embodiments of the present invention, and the embodiments of the present invention are not limited to the network structures in the foregoing FIG. 1 and FIG. 2.

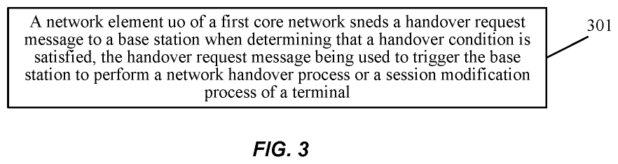

FIG. 3 is a schematic flowchart I of a method for triggering a network handover according to an embodiment of the present invention. As shown in FIG. 3, the method for triggering the network handover includes the following step:

Step 301: A request message is sent to a base station when a network element of a first core network determines that a handover condition is satisfied, the request message being used to trigger a base station to perform a network handover process or a session modification process of a terminal.

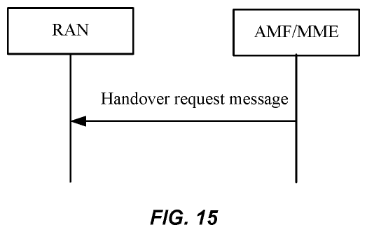

During specific implementation, the network element of the first core network sends the request message to the base station through network elements of other core networks. That the network element of the first core network is a PCF network element is used as an example. The PCF sends the request message to the base station through an AMF/MME network element. Referring to FIG. 15, the AMF/MME network element sends the request message to a RAN device (a corresponding base station).

The network element of the first core network determines that the handover condition is satisfied in the following but being not limited to the following manners.

(1) When the network element of the first core network determines that traffic used by the terminal on a first network exceeds a preset threshold, a request message is sent to the base station.

In particular, the network element of the first core network receives a first trigger message sent by a network element of a second core network, the first trigger message being used to indicate that the traffic used by the terminal on the first network exceeds a preset threshold.

(2) When the network element of the first core network determines that the terminal is using one or more specific applications on the first network, a request message is sent to the base station.

In an implementation, the specific applications include at least one of the following: an application that is not supported by the first network, an application that occupies an amount of resources of the first network that exceeds a preset value, an application that is not used on the first network required in subscription information, and an application that is in a low-priority transfer data packet in the subscription information, the low-priority transfer data packet meaning that a priority of the transfer data packet is lower than or equal to a preset priority.

Subscription information includes attribute information corresponding to a plurality of applications, the attribute information including at least one of the following: feature information, service priority information, and importance degree information.

The network element of the first core network selects, according to a current running application, a service priority corresponding to an application with the highest importance degree, and determines, according to the service priority, whether the network handover process or the session modification process is triggered.

Alternatively, the first network element of the first core network calculates, according to one or more current running applications, a sum of importance degrees corresponding to each service priority, and determines, according to the sum of the importance degrees of the service priorities, whether the network handover process or the session modification process is triggered.

During specific implementation, one subscription information list may be added to the subscription information, including feature information corresponding to the plurality of applications, service priority information, and importance degree information (some information herein is optional, such as the importance degree information), and the like. The network element determines, based on the subscription information list, whether handover is triggered, one example thereof being shown in Table 1.

TABLE 1

| | | | |
|---|---|---|---|
| Application-1 | Feature | Service priority | Importance |
| | information 1 | [NR-5GC, | degree 12 |
| | | LTE-5GC, | |
| | | LTE-EPC] | |
| Application-2 | Feature | Service priority | Importance |
| | information 2 | [LTE-5GC] | degree 5 |
| . . . | . . . | . . . | . . . |

The importance degree is a range, such as 1-15, and the service priority may be one value or more values.

A network side device selects, according to a running application, a service priority corresponding to an application with the highest importance degree, and determines, according to the service priority, whether a network handover or session modification is triggered.

Alternatively, the network side device also calculates, according to one or more current running applications, the sum of importance degrees corresponding to service priorities. For example, the current running applications include the following three:

TABLE 2

| | | | |
|---|---|---|---|
| Application-1 | Feature | Service priority | Importance |
| | information 1 | [NR-5GC] | degree 12 |
| Application-2 | Feature | Service priority | Importance |
| | information 2 | [NR-5GC] | degree 5 |
| Application-3 | Feature | Service priority | Importance |
| | information 3 | [LTE-EPC] | degree 8 |
| . . . | . . . | . . . | . . . |

A sum of importance degrees of [NR-5GC] calculated by the network side device is 12+5=17, and a sum of importance degrees of [LTE-EPC] is 8. Therefore, if the UE only supports single registration, [NR-5GC] is selected as a current network for working. If the UE supports dual registration, a data flow of the application-3 may be handed over to LTE-EPC, and data flows of the application-1 and the application-2 are still transferred to NR-5GC.

The foregoing rules may be used by the PCF apparatus, or may be delivered by the PCF apparatus or the UDM apparatus to other network elements such as an SMF apparatus for use.

(3) When the network element of the first core network determines that the terminal moves into a target area or moves away from the target area, the request message is sent to the base station.

(4) When the network element of the first core network receives a second trigger message, the request message is sent to the base station.

In an implementation, the network element of the first core network receives a request message sent by a network element of a third core network. In this case, the network element of the first core network sends the request message to the base station.

In another implementation, the network element of the first core network receives a service request message sent by a terminal, the service request message being used to indicate occurrence or a request handover of specific services (such as an emergency call service and a voice call service). In this case, the network element of the first core network sends the request message to the base station.

In the foregoing solutions, the request message is used to instruct the base station to perform a handover process that some or all of data flows of the terminal on a user plane are handed over from the first network to a second network.

In an implementation, the request message includes at least one of the following indication information: indication information based on an inter-system interface handover, indication information based on redirection without an inter-system interface, indication information of session establishment/request modification, or indication information for handing over a specified application data flow and/or session.

Further, if the request message includes the indication information for handing over a specified application data flow and/or session, the request message further includes indication information for handing over, to a second base station that is connected to the second core network, the specified data flow and/or session from a current first base station that is connected to the first core network, or indication information for handing over, to the second base station that is connected to the first core network, the specified data flow and/or session from the current first base station that is connected to the first core network.

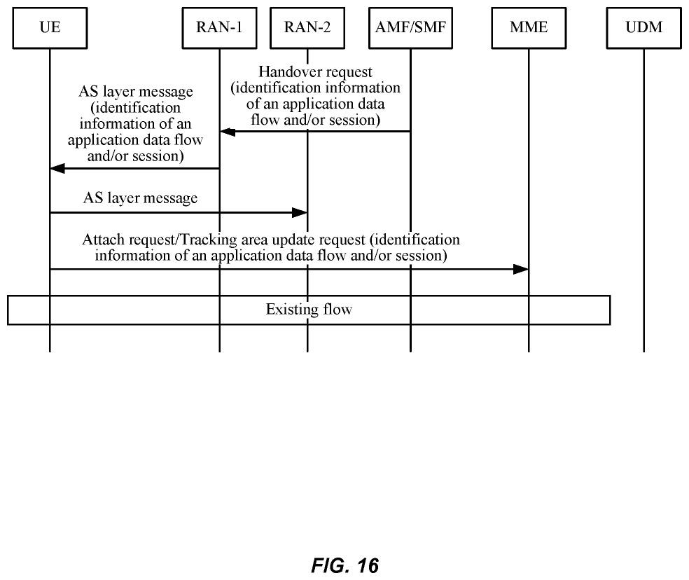

Referring to FIG. 16, a network element of a first core network is an AMF network element or an SMF network element, and an access network corresponding to a base station is RAN-1. RAN-1 and AMF/SMF belong to a first network (namely a 5G network), and RAN-2 and MME belong to a second network (namely a 4G network). A request message sent by the AMF/SMF network element to a RAN-1 network element carries identification information (a flow id list and/or a session id list) of a specified application data flow and/or session, a connected target RAT=RAN-2, and a target core network is an EPC. An air interface message, namely an AS layer message (such as, an RRC connection reconfiguration message or an RRC connection release message) sent by the RAN-1 network element to the UE carries identification information (a flow id list and/or a session id list) of the specified application data flow and/or session. Afterwards, the UE sends the AS layer message to a RAN-2 network element and sends a session establishment message (such as an attach request message or a location update message) to an MME, and the session establishment message carries the identification information (a flow id list and/or a session id list) of the specified application data flow and/or the session, and may further carry other indication information. Next, a second network side device starts establishing a corresponding application data flow and/or session.

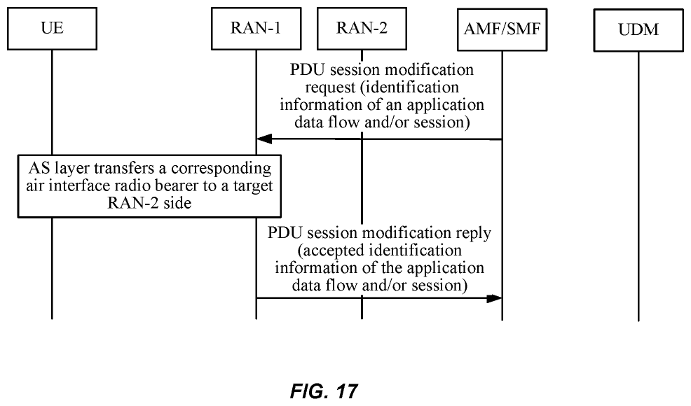

Referring to FIG. 17, a network element of a first core network is an AMF network element or an SMF network element, and an access network corresponding to a base station is RAN-1. Both RAN-1 and RAN-2 belong to a first network (namely a 5G network). A request message sent by the AMF/SMF network element to a RAN-1 network element carries identification information (a flow id list and/or a session id list) of a specified application data flow and/or session, a connected target of RAT=RAN-2, and a target core network is 5GC. The RAN-1 network element interacts with a UE (through an RRC Connection Reconfiguration message) at an air interface, hands over, to a target RAN-2 side, an air interface radio bearer corresponding to a specified flow/PDU Session, and then replies to a flow id list and/or a PDU session id list that are/is shifted by the AMF/SMF network element in the core network.

In the foregoing solutions, the request message carries a network handover type, the network handover type including an access type handover or an access system handover.

The embodiments of the present invention are proposed as follows based on a 5G network architecture.

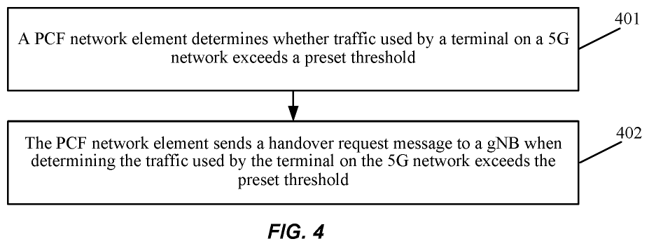

FIG. 4 is a schematic flowchart II of a method for triggering a network handover according to an embodiment of the present invention. As shown in FIG. 4, the method for triggering the network handover includes the following steps.

Step 401: A PCF network element determines whether traffic used by a terminal on a 5G network exceeds a preset threshold.

In an implementation, the PCF network element receives a first trigger message sent by an AMF network element/an SMF network element, the first trigger message being used to indicate that the traffic used by the terminal on the 5G network exceeds the preset threshold.

Step 402: A request message is sent to a gNB when the PCF network element determines that the traffic used by the terminal on the 5G network exceeds the preset threshold.

In the embodiment of the present invention, the request message is used to indicate that the gNB performs a handover process that the terminal is handed over from the 5G network to a 4G network.

In an implementation, the request message carries a network handover type, such as a RAT handover or an EPS handover.

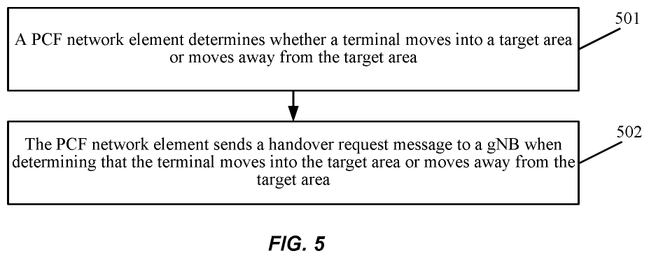

FIG. 5 is a schematic flowchart III of a method for triggering a network handover according to an embodiment of the present invention. As shown in FIG. 5, the method for triggering the network handover includes the following steps:

Step 501: A PCF network element determines whether a terminal moves into a target area or moves away from the target area;

Step 502: A request message is sent to a gNB when the PCF network element determines that the terminal moves into the target area or moves away from the target area.

In the embodiment of the present invention, the request message is used to indicate that the gNB performs a handover process that the terminal is handed over from a 5G network to a 4G network.

In an implementation, the request message carries a network handover type, such as a RAT handover or an EPS handover.

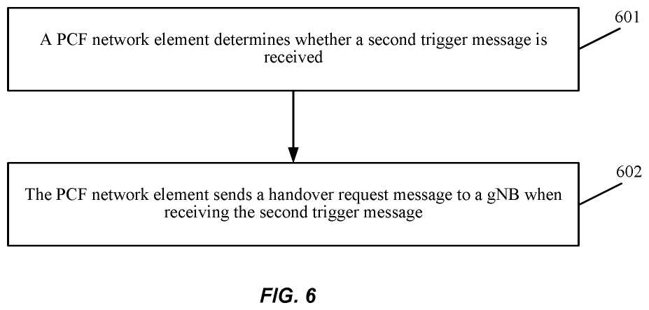

FIG. 6 is a schematic flowchart IV of a method for triggering a network handover according to an embodiment of the present invention. As shown in FIG. 6, the method for triggering the network handover includes the following steps:

Step 601: A PCF network element determines whether a second trigger message is received.

In an implementation, if the PCF network element receives a request message sent by an AF network element, it is determined that the second trigger message is received.

The request message herein sent by the AF network element may also carry a network handover type, for example, a RAT handover or an EPS handover.

Step 602: The PCF network element sends the request message to a gNB when receiving the second trigger message.

In an implementation, the request message carries a network handover type, such as a RAT handover or an EPS handover.

In the embodiment of the present invention, the request message is used to indicate that the gNB performs a handover process that the terminal is handed over from a 5G network to a 4G network.

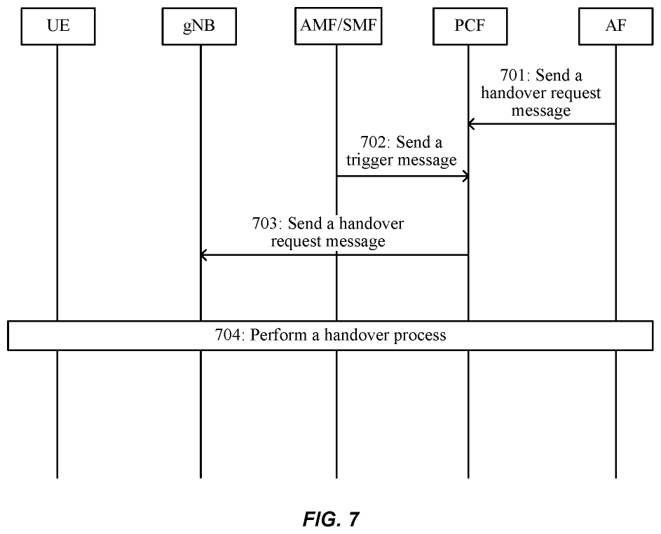

FIG. 7 is a schematic flowchart V of a method for triggering a network handover according to an embodiment of the present invention. As shown in FIG. 7, the method for triggering the network handover includes the following steps:

Step 701: An AF network element sends a request message to a PCF network element.

The request message herein carries a network handover type, for example, a RAT handover or an EPS handover.

Step 702: An AMF/SNIF network element sends a trigger message to the PCF network element, the trigger message being used to indicate that traffic used by a terminal on a 5G network exceeds a preset threshold.

In the foregoing solutions, a sequence of performing step 701 and step 702 is not limited.

Step 703: The PCF network element sends a request message to a gNB.

The request message herein carries a network handover type, for example, a RAT handover or an EPS handover.

Step 704: A UE performs a handover process with network elements at a network side.

According to the technical solutions of the embodiments of the present invention, the PCF network element can immediately trigger the UE to return to the 4G network when learning that the traffic used by the UE on the 5G network reaches an upper limit.

Embodiments of the present invention are proposed as follows based on a 4G network architecture.

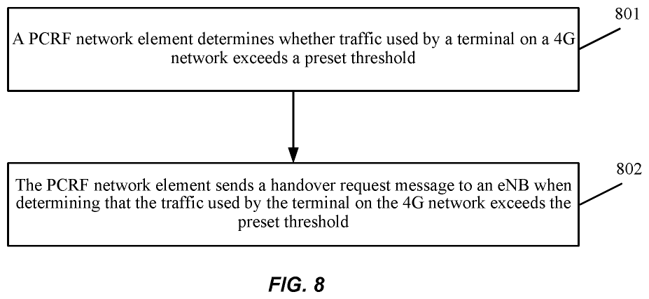

FIG. 8 is a schematic flowchart VI of a method for triggering a network handover according to an embodiment of the present invention. As shown in FIG. 8, the method for triggering the network handover includes the following steps.

Step 801: A PCRF network element determines whether traffic used by a terminal on a 4G network exceeds a preset threshold.

In an implementation, the PCF network element receives a first trigger message sent by an MME network element/PDN-GW network element, the first trigger message being used to indicate that the traffic used by the terminal on the 4G network exceeds the preset threshold.

Step 802: A request message is sent to an eNB when the PCRF network element determines that the traffic used by the terminal on the 4G network exceeds the preset threshold.

In the embodiment of the present invention, the request message is used to instruct the eNB to perform a handover process that the terminal is handed over from the 4G network to a 3G network.

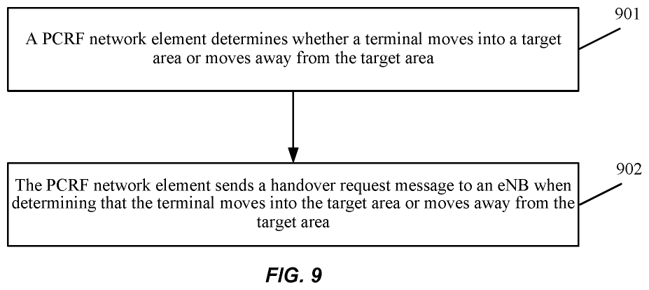

FIG. 9 is a schematic flowchart VII of a method for triggering a network handover according to an embodiment of the present invention. As shown in FIG. 9, the method for triggering the network handover includes the following steps:

Step 901: A PCRF network element determines whether a terminal moves into a target area or moves away from the target area.

Step 902: A request message is sent to an eNB when the PCRF network element determines that the terminal moves into a target area or moves away from the target area.

In the embodiment of the present invention, the request message is used to instruct the eNB to perform a handover process that the terminal is handed over from the 4G network to a 3G network.

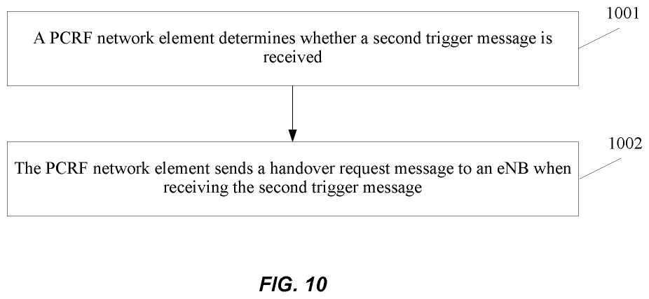

FIG. 10 is a schematic flowchart VIII of a method for triggering a network handover according to an embodiment of the present invention. As shown in FIG. 10, the method for triggering the network handover includes the following steps:

Step 1001: A PCRF network element determines whether a second trigger message is received.

In an implementation, if the PCRF network element receives a request message sent by an AF network element, it is determined that the second trigger message is received.

Step 1002: The PCRF network element sends a request message to an NB when receiving the second trigger message.

In the embodiment of the present invention, the request message is used to instruct the eNB to perform a handover process that the terminal is handed over from a 4G network to a 3G network.

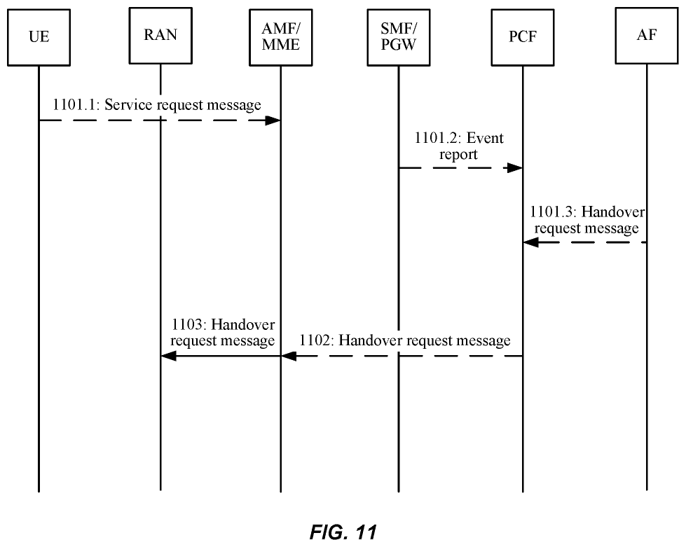

FIG. 11 is a schematic flowchart IX of a method for triggering a network handover according to an embodiment of the present invention. As shown in FIG. 11, the method for triggering the network handover includes the following steps:

Step 1101.1: A UE sends a service request message to an AMF/MME network element.

The service request message herein reported by the UE may be implemented through a current service request message, which can indicate a service type that is requested, such as an emergency call service and a voice call service.

Step 1101.2: An SMF network element/a PGW network element reports an event to a PCF.

The reported event herein includes usage detection and application detection, etc.

Step 1101.3: An AF network element sends a request message to a PCF network element.

Herein, the request message, as a third party trigger request, sent by the AF network element, is actively triggered by a third party server.

The foregoing step 1101.1, step 1101.2, and step 1101.3 all can trigger the handover process, which may be performed independently, or may be performed in parallel.

Step 1102: The PCF network element sends a request message to an AMF/MME network element.

Step 1103: The AMF/MME network element sends a request message to a RAN network element, to trigger a handover process.

In the foregoing solutions, that the terminal is handed over from the 5G network to the 4G network or handed over from the 4G network to the 3G network is only used as an example.

In an actual application, the network handover is not limited thereto. Any network handover implemented based on an idea of technical solutions of the embodiments of the present invention shall fall within the protection scope of the embodiments of the present invention.

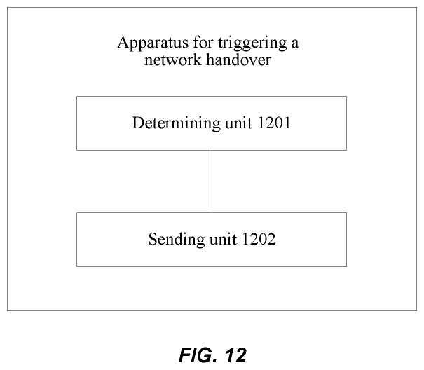

FIG. 12 is a schematic structural diagram I of an apparatus for triggering a network handover according to an embodiment of the present invention. As shown in FIG. 12, the apparatus includes a determining unit 1201, configured to determine whether a handover condition is satisfied, and a sending unit 1202, configured to send a request message to a base station when the handover condition is satisfied, the request message being used to trigger the base station to perform a network handover process or a session modification process of a terminal.

Those skilled in the art should understand that, for implementation functions of the units in the apparatus for triggering the network handover as shown in FIG. 12, reference may be made to related description of the foregoing method for triggering the network handover. Functions of the units in the apparatus for triggering the network handover as shown in FIG. 12 may be implemented through a program running on a processor, or may be implemented through a specific logic circuit.

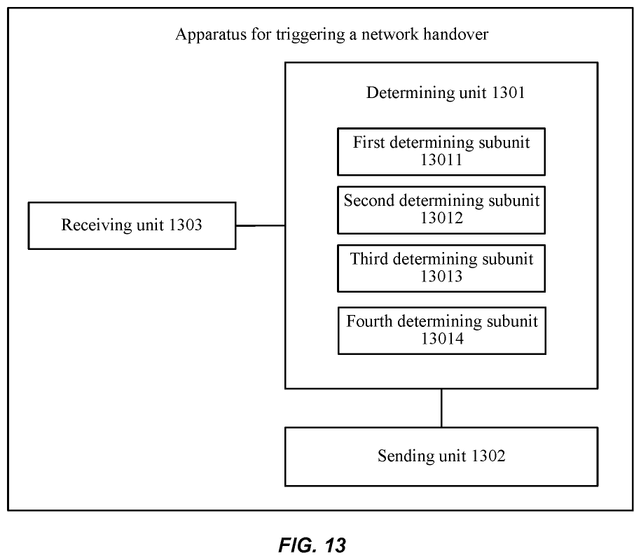

FIG. 13 is a schematic structural diagram II of an apparatus for triggering a network handover according to an embodiment of the present invention. As shown in FIG. 13, the apparatus includes a determining unit 1301, configured to determine whether a handover condition is satisfied; and a sending unit 1302, configured to send a request message to a base station when the handover condition is satisfied, the request message being used to trigger the base station to perform a network handover process or a session modification process of a terminal.

In an implementation, the determining unit 1301 includes a first determining subunit 13011, configured to determine whether traffic used by the terminal on a first network exceeds a preset threshold, and the sending unit 1302 is specifically configured to send a request message to the base station when it is determined that the traffic used by the terminal on the first network exceeds the preset threshold.

In the foregoing solutions, the apparatus further includes a receiving unit 1303, configured to receive a first trigger message sent by a network element of a second core network, the first trigger message being used to indicate that the traffic used by the terminal on the first network exceeds the preset threshold and the first determining subunit 13011 is specifically configured to determine, based on the first trigger message, whether the traffic used by the terminal on the first network exceeds the preset threshold.

In an implementation, the determining unit 1301 includes a fourth determining subunit 13014, configured to determine whether the terminal is using one or more specific applications on the first network and the sending unit 1302 is specifically configured to send the request message to the base station when it is determined that the terminal is using one or more specific applications on the first network.

In an implementation, the specific applications include at least one of the following: an application that is not supported by the first network, an application that occupies an amount of resources of the first network that exceeds a preset value, an application that is not used on the first network required in subscription information, and an application that is in a low-priority transfer data packet in the subscription information, the low-priority transfer data packet meaning that a priority of the transfer data packet is lower than or equal to a preset priority.

In an implementation, subscription information includes attribute information corresponding to a plurality of applications, the attribute information including at least one of the following: feature information, service priority information, and importance degree information.

A service priority corresponding to an application with the highest importance degree is selected according to a current running application, and it is determined, according to the service priority, whether the network handover process or the session modification process is triggered.

Alternatively, a sum of importance degrees corresponding to each service priorities is calculated according to one or more current running applications, and it is determined, according to the sum of importance degrees of service priorities, whether the network handover process or the session modification process is triggered.

In an implementation, the determining unit 1301 includes: a second determining subunit 13012, configured to determine whether the terminal moves into a target area or moves away from the target area.

The sending unit 1302 is specifically configured to send the request message to the base station when it is determined that the terminal moves into the target area or moves away from the target area, the request message being used to trigger the base station to perform the network handover process or the session modification process of the terminal.

In an implementation, the determining unit 1301 includes: a third determining subunit 13013, configured to determine whether a second trigger message is received, and the sending unit 1302 is specifically configured to send the request message to the base station when the second trigger message is received, the request message being used to trigger the base station to perform the network handover process or the session modification process of the terminal.

In an implementation, the third determining subunit 13013 is specifically configured to determine whether a request message sent by a network element of a third core network is received.

In another implementation, the third determining subunit 13013 is specifically configured to determine whether a service request message sent by the terminal is received, the service request message being used to indicate occurrence or a request handover of a specific service.

In an implementation of the present invention, that the request message is used to trigger the base station to perform the network handover process or the session modification process of the terminal means that the request message is used to instruct the base station to perform a handover process that some or all of data flows of the terminal on a user plane are handed over from the first network to a second network.

In an implementation, the request message includes at least one of the following indication information: indication information based on an inter-system interface handover, indication information of session establishment/request modification, indication information based on redirection without an inter-system interface, or indication information for handing over a specified application data flow and/or session.

Further, if the request message includes the indication information for handing over a specified application data flow and/or session, the request message further includes indication information for handing over, to a second base station that is connected to the second core network, the specified data flow and/or session from a current first base station that is connected to the first core network, or indication information for handing over, to the second base station that is connected to the first core network, the specified data flow and/or session from the current first base station that is connected to the first core network.

In an implementation of the present invention, the request message carries a network handover type, the network handover type including an access type handover or an access system handover.

Those skilled in the art should understand that, for implementation functions of the units in the apparatus for triggering the network handover as shown in FIG. 13, reference may be made to related description of the foregoing method for triggering the network handover. Functions of the units in the apparatus for triggering the network handover as shown in FIG. 13 may be implemented through a program running on a processor, or may be implemented through a specific logic circuit.

If the foregoing apparatus for triggering the network handover in the embodiment of the present invention is implemented in a form of a software function module and is sold or used as an independent product, the apparatus may also be stored in one computer storage medium. Based on such understanding, the technical solutions in the embodiments of the present invention or a part thereof that makes a contribution to the prior art may be essentially embodied in a form of a software product. The computer software product is stored in a storage medium, including several instructions to enable one computer device (which may be a personal computer, a server, or a network device, etc.) to perform all or some of the methods in the embodiments of the present invention. The foregoing storage medium includes any medium that can store program code, such as a USB flash disk, a mobile hard disk, a read-only memory (ROM), a magnetic disk, or an optical disk. In this way, the embodiments of the present invention are not limited to any combination of specific hardware and software.

Correspondingly, an embodiment of the present invention further provides a computer storage medium in which a computer executable instruction is stored. The computer executable instruction implements, when executed by a processor, the foregoing method for triggering a network handover in the embodiment of the present invention.

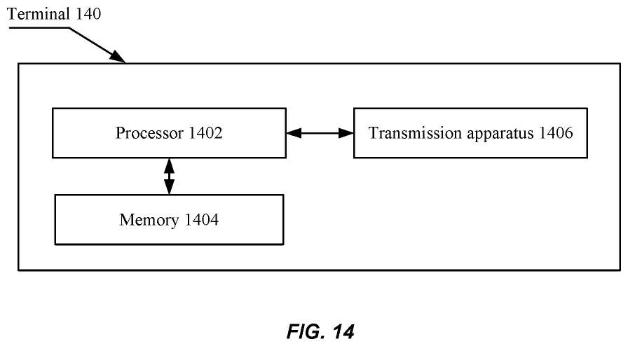

FIG. 14 is a schematic structural diagram of a terminal according to an embodiment of the present invention. As shown in FIG. 14, a terminal 140 may include one or more (only one shown in the figure) processors 1402 (the processors 1402 may include but not limited to a processing apparatus such as a microcontroller unit (MCU) or a field programmable gate array (FPGA)), a memory 1404 for storing data, and a transmission apparatus 1406 for communication. Those skilled in the art may understand that, the structure shown in FIG. 14 is merely an example and does not constitute a limitation on the structure of the foregoing electronic apparatus. For example, the terminal 140 may further include more or less components than those shown in FIG. 14, or has a configuration different from that shown in FIG. 14.

The memory 1404 may be configured to store a software program of application software and a module, such as a program instruction/module corresponding to the method for triggering the network handover in the embodiment of the present invention, and the processor 1402 executes various functional applications and data processing through running the software program and the module stored in the memory 1404, to implement the foregoing method. The memory 1404 may include a high-speed random memory, and may further include a non-volatile memory such as one or more magnetic storage apparatuses, a flash memory, or other non-volatile solid state memories. In some embodiments, the memory 1404 may further include memories that are remotely disposed relative to the processor 1402, and these remote memories may be connected to the terminal 140 via a network. Examples of the foregoing networks include, but are not limited to, an internet, an intranet, a local area network, a mobile communication network, and a combination thereof.

The transmission apparatus 1406 is configured to receive or send data via a network. A specific example of the foregoing network may include a wireless network provided by a communication supplier of the terminal 140. In an example, the transmission apparatus 1406 includes one network interface controller (NIC), which can be connected to other network devices through a base station, thereby communicating with the Internet. In an example, the transmission apparatus 1406 may be a radio frequency (RF) module, which is configured to communicate with the internet in a wireless mode.

The technical solutions set forth in the embodiments of the present invention may be arbitrarily combined with each other without conflicts.

In the several embodiments provided in the present invention, it should be understood that the disclosed method and intelligent device may be implemented in other manners. The described device embodiment is merely an example. For example, the unit division is merely logical function division and may be other division during actual implementation. For example, a plurality of units or components may be combined or integrated into another system, or some features may be ignored or not performed. In addition, the displayed or discussed mutual couplings or direct couplings or communication connections between the components may be implemented through some interfaces. The indirect couplings or communication connections between the devices or units may be implemented in electronic, mechanical, or other forms. The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments. In addition, functional units in the embodiments of the present invention may all be integrated into one second processing unit, or each of the units may be implemented as an independent unit, or two or more units may be integrated into one unit. The integrated unit may be implemented in a form of hardware, or may be implemented in a form of hardware in addition to a software functional unit.

The foregoing descriptions are merely specific implementations of the present invention, but are not intended to limit the protection scope of the present invention. Any variation or replacement readily figured out by a person skilled in the art within the technical scope disclosed in the present invention shall fall within the protection scope of the present invention.

What is claimed is:

1. A method for triggering a network handover, the method comprising:
determining, by a Core Access and Mobility Management Function (AMF) of a 5G Core network, whether a switchover condition is satisfied;
when determining that the switchover condition is satisfied, sending, by the AMF of the 5G Core network, a request message to a Radio Access Network (RAN) node, wherein:
the request message comprises one of:
first indication information for indicating the RAN node to perform an inter-Radio Access Technology (RAT) switchover, wherein the inter-RAT switchover is to handover or redirect a terminal from a New Radio (NR) node to an evolved universal terrestrial radio access network (E-UTRA) node, the NR node and the E-UTRA node connected to a same 5G Core network; or
second indication information for indicating the RAN node to perform an inter-system switchover, wherein the switchover is to handover or redirect a terminal from a 5G system to a 4G system;
the handover is performed with an inter-system interface; and
the redirection is performed without the inter-system interface.

2. The method of claim 1 wherein determining whether a switchover condition is satisfied comprises:
receiving, by the AMF of the 5G Core network, a service request message sent by the terminal, the service request message being used to indicate occurrence of an emergency service.

3. The method of claim 1 wherein sending, by the AMF of the 5G Core network, a request message to the RAN node comprises:
sending, by the AMF of the 5G Core network, the request message to the RAN node when determining that traffic used by the terminal on a first network exceeds a preset threshold.

4. The method of claim 3, wherein determining that traffic used by the terminal on the first network exceeds a preset threshold comprises:
receiving, by the AMF of the 5G Core network, a first trigger message sent by a network element of a 4G core network, the first trigger message being used to indicate that the traffic used by the terminal on the first network exceeds the preset threshold.

5. The method of claim 1 wherein sending, by the AMF of the 5G Core network, a request message to a RAN node comprises:
sending, by the AMF of the 5G Core network, the request message to the RAN node when determining that the terminal is using one or more specific applications on a first network.

6. The method of claim 5, wherein the specific applications comprise at least one of:
an application that is not supported by the first network;
an application that occupies an amount of resources of the first network that exceeds a preset value;
an application that is not used on the first network required in subscription information; or
an application that is in a low-priority transfer data packet in the subscription information, the low-priority transfer data packet indicating that a priority of the low-priority transfer data packet is lower than or equal to a preset priority.

7. The method of claim 1 wherein sending, by the AMF of the 5G Core network, a request message to the RAN node comprises:
sending, by the AMF of the 5G Core network, the request message to the RAN node when receiving a second trigger message, the request message being used to trigger the RAN node to perform the handover or the redirection.

8. The method for triggering the network handover of claim 1 wherein the request message further comprises at least one of:
indication information of session establishment modification or request modification; or
indication information for handing over at least one of a specified application data flow or session.

9. An apparatus for triggering a network handover, the apparatus comprising:
a communication interface;
a memory configured to store computer-executable instructions; and
one or more processors in communication with the communication interface and the memory and configured to execute the computer-executable instructions to at least:
determine, by a Core Access and Mobility Management Function (AMF) of a 5G Core network, whether a switchover condition is satisfied;
when determining that a switchover condition is satisfied, send via the communication interface, by the AMF of the 5G Core network, a request message to a Radio Access Network (RAN) node, wherein:
the request message comprises one of:
first indication information for indicating a RAN node to perform an inter-Radio Access Technology (RAT) switchover, wherein the inter-RAT switchover is to handover or redirect a terminal from a New Radio (NR) node to an evolved universal terrestrial radio access network (E-UTRA) node, the NR node and the E-UTRA node connected to a same 5G Core network; or
second indication information for indicating a RAN node to perform inter-system switchover, wherein the switchover is to handover or redirect a terminal from a 5G system to a 4G system;
the handover is performed with an inter-system interface; and
the redirection is performed without the inter-system interface.

10. The apparatus of claim 9 wherein determining whether a switchover condition is satisfied comprises:
receiving, by the AMF of the 5G Core network, a service request message sent by the terminal, the service request message being used to indicate occurrence of an emergency service.

11. The apparatus of claim 9 wherein sending, by the AMF of the 5G Core network, a request message to the RAN node comprises:
sending, by the AMF of the 5G Core network, the request message to the RAN node when determining that traffic used by the terminal on a first network exceeds a preset threshold.

12. The apparatus of claim 11, wherein determining that traffic used by the terminal on the first network exceeds a preset threshold comprises:
receiving, by the AMF of the 5G Core network, a first trigger message sent by a network element of a 4G core network, the first trigger message being used to indicate that the traffic used by the terminal on the first network exceeds the preset threshold.

13. The apparatus of claim 9 wherein sending, by the AMF of the 5G Core network, a request message to a RAN node comprises:
sending, by the AMF of the 5G Core network, the request message to the RAN node when determining that the terminal is using one or more specific applications on a first network.

14. The apparatus of claim 13, wherein the specific applications comprise at least one of:
an application that is not supported by the first network;
an application that occupies an amount of resources of the first network that exceeds a preset value;
an application that is not used on the first network required in subscription information; or
an application that is in a low-priority transfer data packet in the subscription information, the low-priority transfer data packet indicating that a priority of the low-priority transfer data packet is lower than or equal to a preset priority.

15. The apparatus of claim 9 wherein sending, by the AMF of the 5G Core network, a request message to the RAN node comprises:
sending, by the AMF of the 5G Core network, the request message to the RAN node when receiving a second trigger message, the request message being used to trigger the RAN node to perform the handover or the redirection.

16. The apparatus for triggering the network handover of claim 9 wherein the request message comprises at least one of:
indication information of session establishment modification or request modification; or
indication information for handing over at least one of a specified application data flow or session.

17. A computer-readable storage medium storing computer-executable instructions that, when executed by a computer system, configure the computer system to perform operations comprising:
determining, by a Core Access and Mobility Management Function (AMF) of a 5G Core network, whether a switchover condition is satisfied;
when determining that the switchover condition is satisfied, sending, by the AMF of the 5G Core network, a request message to a Radio Access Network (RAN) node, wherein:
the request message comprises one of:
first indication information for indicating the RAN node to perform an inter-Radio Access Technology (RAT) switchover, wherein the inter-RAT switchover is to handover or redirect a terminal from a New Radio (NR) node to an evolved universal terrestrial radio access network (E-UTRA) node, the NR node and the E-UTRA node connected to a same 5G Core network; or
second indication information for indicating the RAN node to perform an inter-system switchover, wherein the switchover is to handover or redirect a terminal from a 5G system to a 4G system;
the handover is performed with an inter-system interface; and
the redirection is performed without the inter-system interface.

18. The computer-readable storage medium of claim 17 wherein determining whether a switchover condition is satisfied comprises:
receiving, by the AMF of the 5G Core network, a service request message sent by the terminal, the service request message being used to indicate occurrence of an emergency service.

19. The computer-readable storage medium of claim 17 wherein sending, by the AMF of the 5G Core network, a request message to the RAN node comprises:
sending, by the AMF of the 5G Core network, the request message to the RAN node when determining that traffic used by the terminal on a first network exceeds a preset threshold.

20. The computer-readable storage medium of claim 19 wherein determining that traffic used by the terminal on the first network exceeds a preset threshold comprises:
receiving, by the AMF of the 5G Core network, a first trigger message sent by a network element of a 4G core network, the first trigger message being used to indicate that the traffic used by the terminal on the first network exceeds the preset threshold.

21. The computer-readable storage medium of claim 17 wherein sending, by the AMF of the 5G Core network, a request message to a RAN node comprises:
sending, by the AMF of the 5G Core network, the request message to the RAN node when determining that the terminal is using one or more specific applications on a first network.

22. The computer-readable storage medium of claim 21 wherein the specific applications comprise at least one of:
an application that is not supported by the first network;
an application that occupies an amount of resources of the first network that exceeds a preset value;
an application that is not used on the first network required in subscription information; or
an application that is in a low-priority transfer data packet in the subscription information, the low-priority transfer data packet indicating that a priority of the low-priority transfer data packet is lower than or equal to a preset priority.

23. The computer-readable storage medium of claim 17 wherein sending, by the AMF of the 5G Core network, a request message to the RAN node comprises:
sending, by the AMF of the 5G Core network, the request message to the RAN node when receiving a second trigger message, the request message being used to trigger the RAN node to perform the handover or the redirection.

24. The computer-readable storage medium of claim 17 wherein the request message comprises at least one of:
indication information of session establishment modification or request modification; or
indication information for handing over at least one of a specified application data flow or session.
